(19) United States
(12) Patent Application Publication
(10) Pub. No.: US 2010/0252962 A1
(43) Pub. Date: Oct. 7, 2010

(54) MOLDING METHOD AND MOLDING APPARATUS

(75) Inventors: Ayato Ueha, Tochigi (JP); Atsushi Koizumi, Tochigi (JP); Susumu Horinaka, Tochigi (JP)

Correspondence Address: RANKIN, HILL & CLARK LLP, 38210 GLENN AVENUE, WILLOUGHBY, OH, 44094-7808, US

(73) Assignee: HONDA MOTOR CO., LTD., Tokyo (JP)

(21) Appl. No.: 12/158,571

(22) PCT Filed: Dec. 6, 2006
(86) PCT No.: PCT/JP2006/324364

§ 371 Date: Jun. 20, 2008

(30) Foreign Application Priority Data
Dec. 22, 2005 (JP) 2005-369144

(51) Int. Cl. B29C 45/77; B29C 45/78

(52) U.S. Cl. 264/500; 425/72.1

(57) ABSTRACT

A molding method for a resin product having a thick portion projecting outwardly on a rear surface of the resin product includes: a first step for supplying a melted resin into a cavity of a die by an amount which is less than a volume of the cavity. The cavity has a surface side cavity surface corresponding to a surface of the resin product and a rear surface side cavity surface corresponding to the rear surface of the resin product. The molding method further includes: a second step for supplying a gas from the rear surface side cavity surface of the cavity into the cavity, so that the melted resin is separated from the rear surface side cavity surface of the cavity and closely contacts the surface side cavity surface of the cavity; and a third step for solidifying the melted resin maintained in the condition set in the second step.

### TECHNICAL FIELD

The present invention relates to a molding method and to a molding apparatus for molding a resin product having a thick portion projecting outwardly on a rear surface thereof.

### BACKGROUND ART

In the molding of a resin product having a thick portion projecting outwardly on a rear surface thereof, a sink mark (recess) may be formed on a surface of the thick portion of the resin product by the contraction of the resin. Due to this, the appearance of the resin product is deteriorated. In order to solve this problem, as disclosed in Japanese Unexamined Patent Application Publication No. 11-198165, a technique has been proposed in which pressure is applied to a melted resin filled in a cavity of a die, and the melted resin on which the pressure is maintained is solidified so that the contraction degree of the resin is compensated for, and the formation of a sink mark is thereby prevented. In this technique, while the pressure on the melted resin is maintained, a pressurized gas is simultaneously supplied from a rear surface side cavity surface of the die, which corresponds to the rear surface of the resin product, into the cavity, so that the melted resin is pressed on a surface side cavity surface of the die, which corresponds to the surface of the resin product.

However, in this technique, if the maintenance of the pressure on the melted resin is not appropriately performed, a recess will be easily formed on the surface of the resin product. In addition, since the supplying of the pressurized gas is simultaneously performed while the pressure on the resin is maintained, the pressure of the supplied gas must be set high, and it is therefore necessary to use an expensive molding apparatus. Since the maintenance process of the pressure on the resin is necessary, the production cycle is time-consuming, and productivity is thereby deteriorated.

### DISCLOSURE OF THE INVENTION

The present invention was made in consideration of the above problems. Therefore, an object thereof is to provide a molding method and a molding apparatus which can prevent formation of recesses on surfaces of resin products, can reduce molding apparatus cost, and can improve productivity.

According to one aspect of the present invention, a molding method for a resin product having a thick portion projecting outwardly on a rear surface of the resin product was made in order to solve the above problems. The molding method includes: a first step for supplying a melted resin into a cavity of a die by an amount which is less than a volume of the cavity. The cavity has a surface side cavity surface corresponding to a surface of the resin product and a rear surface side cavity surface corresponding to the rear surface of the resin product. The molding method further includes: a second step for supplying a gas from the rear surface side cavity surface of the cavity into the cavity, so that the melted resin is separated from the rear surface side cavity surface of the cavity and closely contacts the surface side cavity surface of the cavity; and a third step for solidifying the melted resin maintained in the condition set in the second step.

According to another aspect of the present invention, a molding apparatus for a resin product having a thick portion projecting outwardly on a rear surface of the resin product was made in order to solve the above problems. The molding apparatus includes: a supplying control device for supplying a melted resin into a cavity of a die by an amount which is less than a volume of the cavity. The cavity has a surface side cavity surface corresponding to a surface of the resin product and a rear surface side cavity surface corresponding to the rear surface of the resin product. The molding apparatus further includes: a gas supplying device for supplying a gas from the rear surface side cavity surface of the cavity into the cavity, so that the melted resin is separated from the rear surface side cavity surface of the cavity and closely contacts the surface side cavity surface of the cavity; and a temperature control device for controlling a temperature of the surface side cavity surface so as to be higher than that of the rear surface side cavity surface.

In the above structure of the present invention, the gas is supplied from the rear surface side cavity surface of the cavity into the cavity, so that the rear surface side of the melted resin is separated from the rear surface side cavity surface of the cavity, and the surface side of the melted resin closely contacts the surface side cavity surface of the cavity. Therefore, solidification of the melted resin on the surface side starts, so that the surface side of the melted resin adheres to the surface side cavity surface of the cavity, and a sink mark (recess) is thereby formed on the rear surface side of the melted resin. As cooling progresses, solidification of the melted resin on the rear surface side starts. However, in this case, the surface side of the melted resin has been already solidified. As a result, no sink mark is formed on the surface side of the melted resin.

The present invention can use various structures. According to a preferred embodiment, a recess for forming the thick portion of the resin product is provided on the rear surface side cavity surface of the cavity, and the gas is supplied from a bottom surface of the recess and a neighborhood of the recess into the cavity. In this embodiment, since the gas can be concentrated at the thick portion and the neighborhood thereof, separation of the thick portion from the die can be performed efficiently.

According to the molding method or the molding apparatus of the present invention, no recess is formed on the surface of the product, the pressure of the gas supplied from the rear surface side cavity surface to the cavity is low, and apparatus cost can be reduced.

In addition, since maintenance process of pressure on resin is unnecessary, the cycle time is shortened and the productivity can be improved.

### BRIEF DESCRIPTION OF THE DRAWINGS

FIG. 1 is a diagram showing a first process of a molding method according to an embodiment of the present invention.

FIG. 2 is a diagram showing a second process of a molding method according to an embodiment of the present invention.

FIG. 3 is a diagram showing a third process of a molding method according to an embodiment of the present invention.

FIG. 4 is a diagram showing a fourth process of a molding method according to an embodiment of the present invention.

FIG. 5 is a diagram showing a fifth process of a molding method according to an embodiment of the present invention.

FIG. 6 is a diagram showing a product produced by a molding method according to an embodiment of the present invention.

FIG. 7 is a diagram showing a molding apparatus used in an embodiment of the present invention.

FIG. 8 is a cross sectional view showing a die of the molding apparatus shown in FIG. 7.

FIG. 9 is a diagram showing a temperature change in the resin existing in a die.

FIG. 10 is a diagram showing a temperature region of a die.

FIG. 11 is a diagram explaining a temperature range of a die.

FIG. 12 is a diagram explaining a temperature change in the resin existing in a die.

FIGS. 13A and 13B are diagrams for showing a difference in the cycle time between an example of the present invention and a conventional example.

FIG. 14 is a diagram showing a change in the molded condition depending on the die temperature.

FIG. 15 is a diagram showing a cover as a specific example of a product produced by a molding method according to an embodiment of the present invention.

FIG. 16 is a diagram showing a motor scooter using the cover shown in FIG. 15.

### EXPLANATION OF REFERENCE NUMERALS

1 denotes a fixed die, 2 denotes a movable die, 3 denotes a cavity, 4 denotes a melted resin, 5 denotes a recess for forming a rib, 9 denotes a supplying control device, 12 denotes a temperature control device, 13 denotes a gas supplying device, 14 denotes a gas supplying passage, 14A and 14B denote opening portions, W denotes a product, R denotes a rib, and h denotes a sink mark.

### BEST MODE FOR CARRYING OUT THE INVENTION

An embodiment of the present invention will be described hereinafter with reference to the Figures.

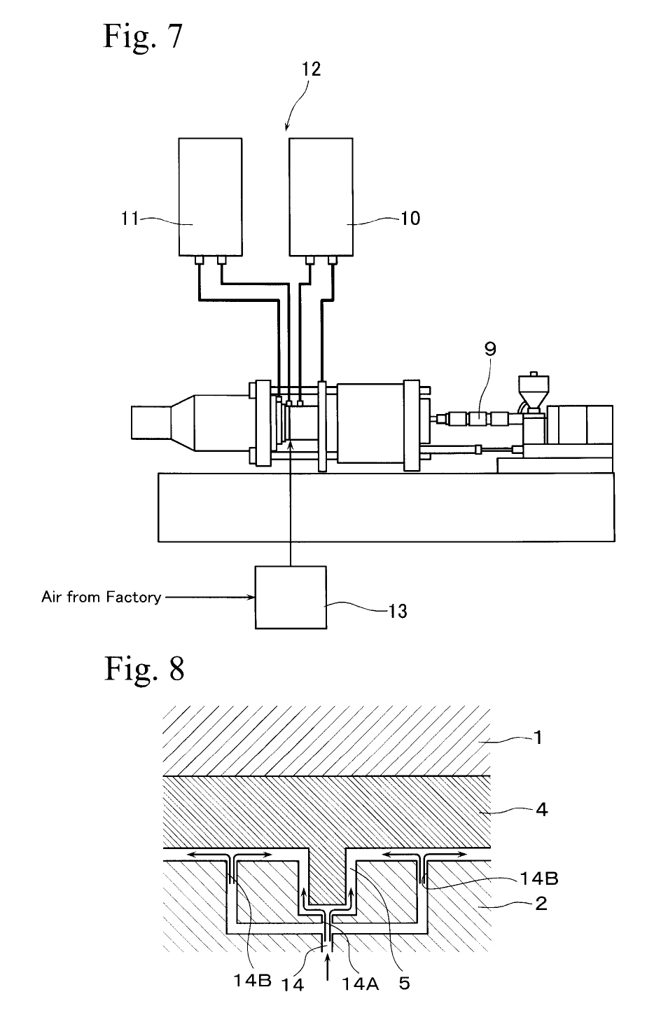

FIG. 7 is a diagram showing a molding apparatus used in an embodiment of the present invention. The molding apparatus is equipped with a supplying control device 9 for supplying a melted resin into a cavity of a die by an amount which is less than the volume of the cavity. The molding apparatus is equipped with a temperature control device 12 having hot water supplying sections 10 and 11. The hot water supplying section 10 controls the temperature of a fixed die 1 by supplying hot water thereto. The hot water supplying section 11 controls the temperature of a movable die 2 by supplying hot water thereto. The molding apparatus is equipped with a gas supplying device 13 for supplying the air from factory into the movable die 2.

FIG. 8 shows a position of a gas supplying passage 14 in the movable die 2. The movable die 2 has a cavity surface corresponding to a rear surface of a product. The cavity surface of the movable die 2 has plural recesses 5 for forming a rib of a product and a flat plate forming portion formed around the recesses 5, the rib being a thick portion projecting outwardly from the rear surface of the product. For example, the gas supplying passage 14 opens to the recesses 5 and the flat plate forming portion on the cavity surface of the movable die 2, so that opening portions 14A and 14B are formed thereat. Sintered steels (not shown in FIG. 8) are disposed at the opening portions 14A and 14B for preventing a melted resin 4 from entering into the gas supplying passage 14. The supplied gas in the die need not be maintained in the die, and may be discharged from a portion (for example, contacting surfaces) of the die to the outside. That is, it is unnecessary to seal the supplied air, so that the apparatus cost can be reduced. In addition, the opening portions 14B are disposed proximate to the recess 5, so that the air can be concentrated at the thick portion and the neighborhood therearound. As a result, separation of the thick portion of the product from the die can be performed efficiently.

Next, a molding method for molding a product, which uses the above molding apparatus, will be explained hereinafter.

The temperature of the die having the fixed die 1 and the movable die 2 is set at the following values by the temperature control device 12 in advance. Therefore, since the temperature of the die is higher than the typical value (40 degrees C. to 50 degrees C.), a melted resin can closely contact the cavity surface.

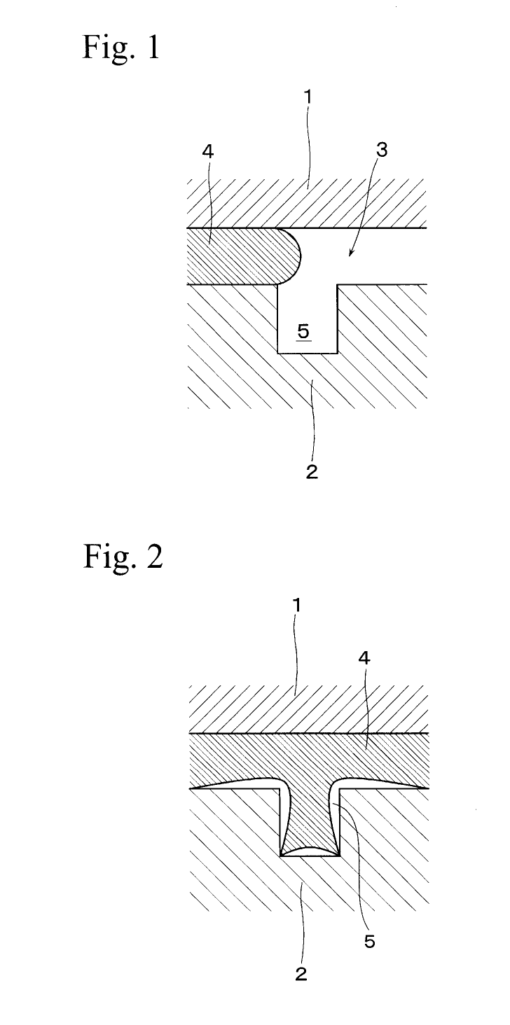

First, as shown in FIG. 1, a melted resin 4 is supplied into the cavity 3 between the fixed die 1 and the movable die 2. It is most desirable that the supplied amount of the melted resin 4 be 11% less than the volume of the cavity 3. In consideration of control range, the supplied amount of the melted resin 4 may be 3% to 20% less than the volume of the cavity 3.

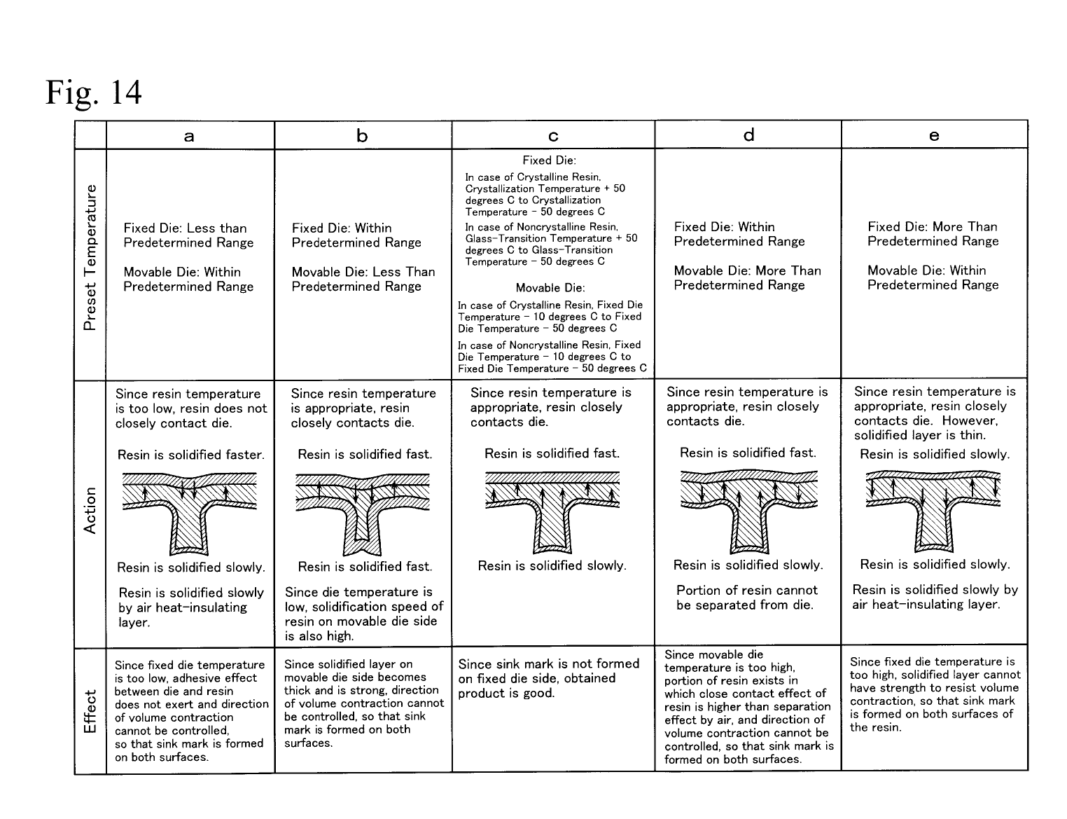

After the supplying of the melted resin 4 is completed, cooling of the melted resin 4 is started by supplying cold water to the fixed die 1 and the movable die 2. The processing desirably changes over to the cooling immediately after the supplying of the melted resin 4 is completed. In consideration of variability in the action of the molding apparatus, in practice, time interval between the supplying and the cooling is about 0.2 second as shown in FIG. 13B.

Next, the gas supplying device 13 is activated, so that a gas is supplied from the cavity surface of the movable die 2 into the cavity 3 without a pressure being applied to the melted resin 4. As a result, the melted resin 4 is separated from the cavity surface of the movable die 2, as shown in FIG. 2. The supplying of the gas is performed from the supplying of the melted resin to the cooling thereof as shown in FIG. 13B.

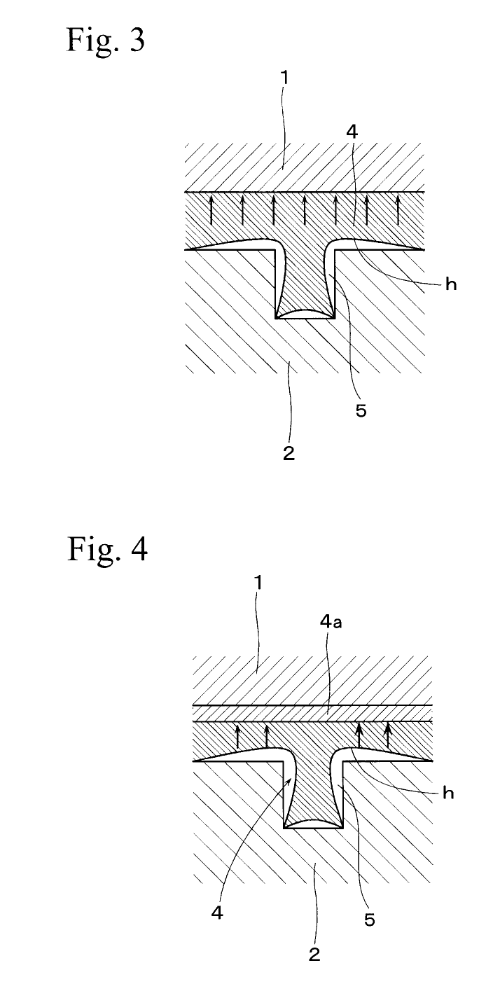

The amount of the melted resin 4, which is less than the volume of the cavity 3, is in the cavity 3. Therefore, when the gas is supplied from the movable die 2 into the cavity 3, the melted resin 4 is pressed on the cavity surface of the fixed die 1 by the pressure of the supplied gas. This action by the pressure of the supplied gas is referred to as “air assist” hereinafter. Since the temperature of the die is set to be higher than the typical value described above, force works on the melted resin 4 existing in the cavity 3, so that the melted resin 4 closely contacts the cavity surface of the fixed die 1 as shown in FIG. 3.

Therefore, as shown in FIG. 4, the melted resin 4 closely contacts the cavity surface of the fixed die 1, and solidification of the melted resin 4 starts on the surface side thereof proximate to the cavity surface of the fixed die 1. In accordance with the formation of solidified layer 4a on the surface side proximate to the cavity surface of the fixed die 1, the melted resin 4 adheres to the cavity surface of the fixed die 1, and formation of sink mark h starts on the rear surface side thereof proximate to the cavity surface of the movable die 2.

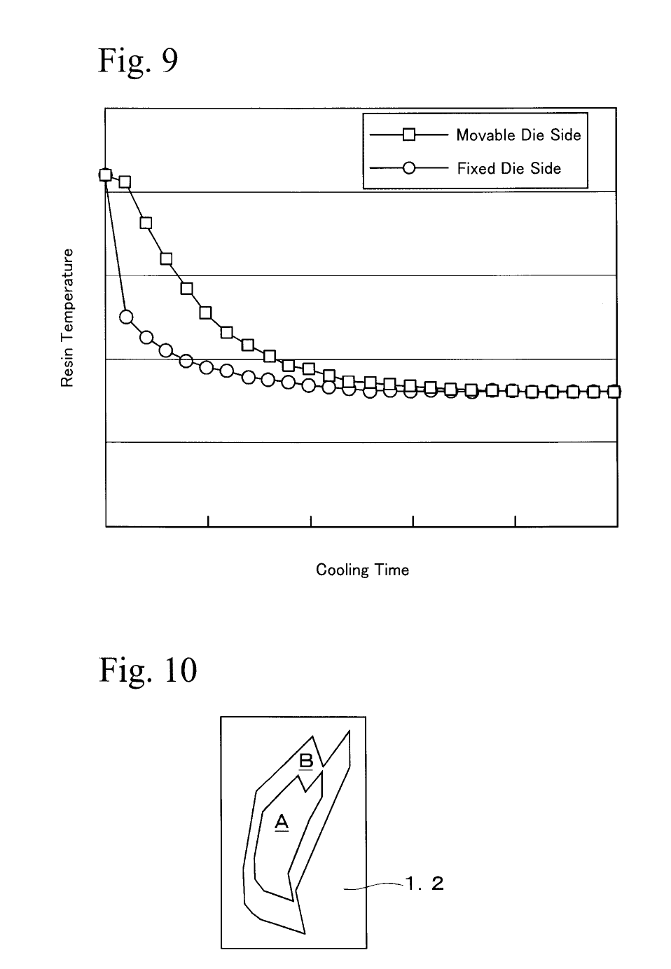

On the other hand, since the rear surface side of the melted resin 4 is separated from the cavity surface of the movable die 2 by the supplying of the gas, and a heat insulating layer is formed between the melted resin 4 and the cavity surface of the movable die 2, the cooling rate of the rear surface side of the melted resin 4 is lower than that of the surface side of the melted resin 4. Therefore, formation of a solidified layer does not start on the rear surface side of the melted resin 4. FIG. 9 shows temperature changes of the melted resin 4 on the sides of the fixed die 1 and the movable die 2. That is, as shown in FIG. 9, the cooling rate of the melted resin 4 proximate to the movable die 2 is lower than that proximate to the fixed die 1.

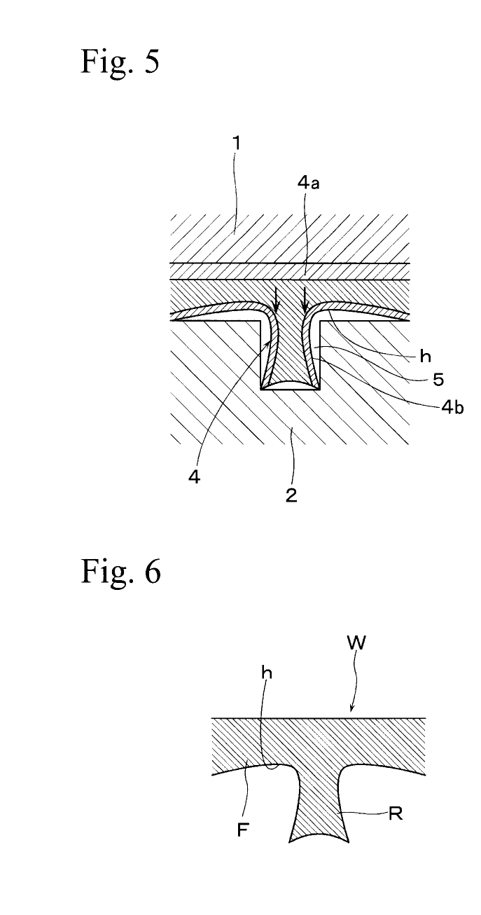

As the cooling progresses, a solidified layer 4b is formed on the rear surface side of the melted resin 4 as shown in FIG. 5. In this case, since the solidified layer 4a has already been formed on the surface side of the melted resin 4, the surface side of the melted resin 4 is not drawn by contraction of the rear surface side thereof. As a result, no sink mark is formed on the surface side of the product.

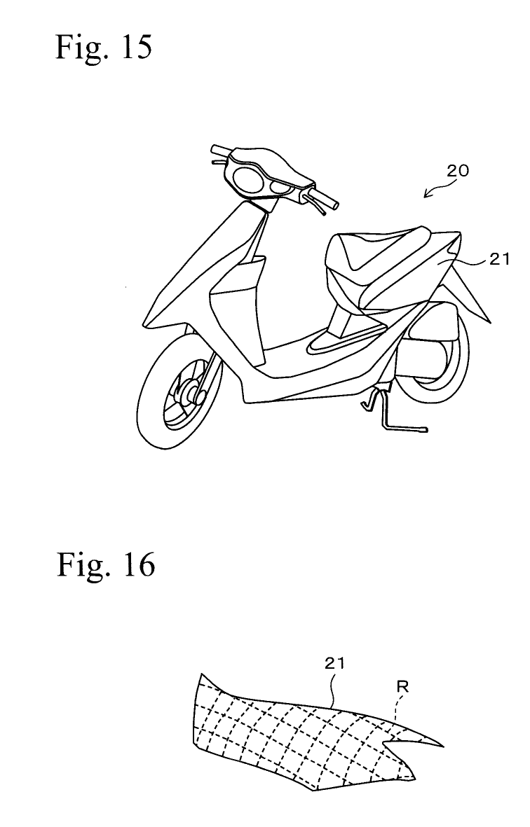

FIG. 6 shows a product W molded in the above manner. The sink mark h is concentrated on the rear surface side of the product W and it is formed from a plate portion F to a rib R thereof. However, the sink mark h is not formed on the surface side of the product W. In addition, no recess is formed on the surface side of the product W. A cover 21, which is provided on a motor scooter 20 shown in FIG. 15, is a specific example of the product W. FIG. 16 is an enlarged diagram of the cover 21. Plural ribs R are formed on a rear surface side of the cover 21.

Since the supplied amount of the melted resin 4 is 3% to 20% less than the volume of the cavity 3, the cavity 3 has a space in which the melted resin 4 can move to the fixed die 1 even when the supplied pressure of the gas to the cavity 3 is low. That is, the air assist can be performed. When the unsupplied ratio of the melted resin 4 in the cavity 3 is less than 3%, the melted resin 4 is completely filled at a portion of the cavity 3, so that the cavity 3 does not have a space in which the melted resin 4 can move to the fixed die 1. On the other hand, when the unsupplied ratio of the melted resin 4 in the cavity 3 exceeds 20%, the absolute amount of the melted resin 4 is insufficient, so that it is difficult to maintain a predetermined shape of the product W.

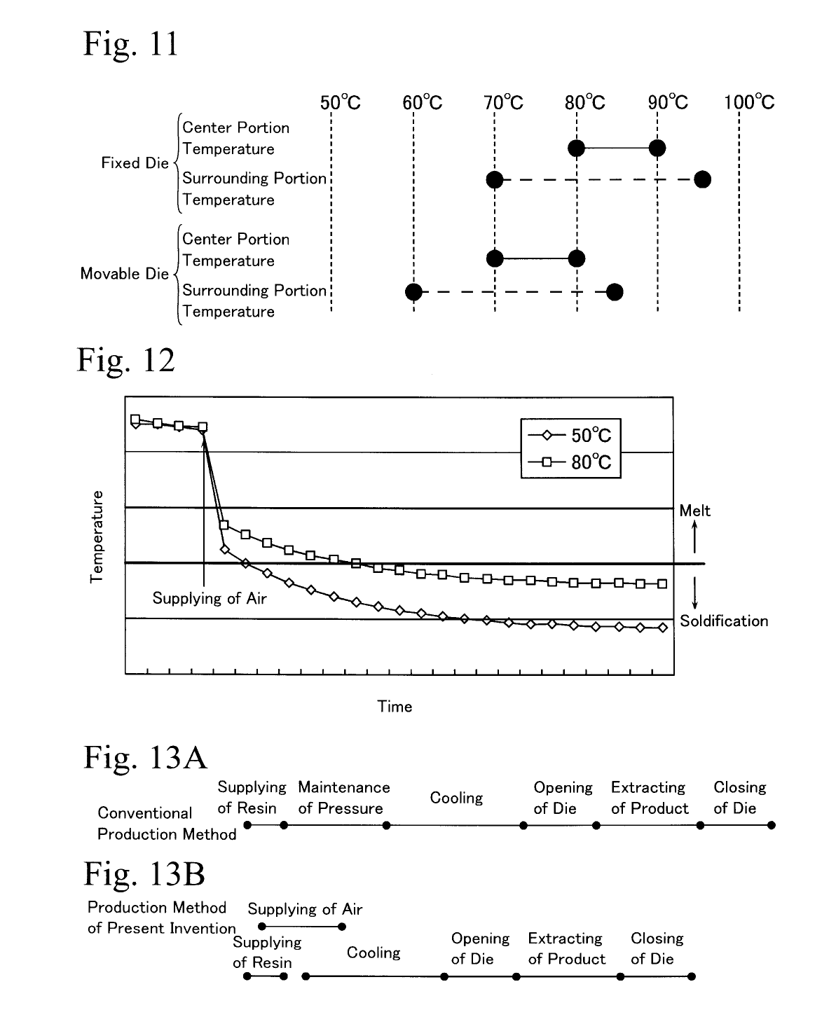

FIG. 11 shows a practical example of the temperature setting range of the die. In the fixed die 1, a center portion has a temperature of 80 to 90 degrees C. and a surrounding portion has a temperature of 80 to 95 degrees C. In the movable die 2, a center portion has a temperature of 70 to 80 degrees C. and a surrounding portion has a temperature of 60 to 85 degrees C. Each center portion is a center portion of the cavity 3 and is defined by an area A shown in FIG. 10. Each surrounding portion is a surrounding portion of the cavity 3 and is defined by an area B shown in FIG. 10.

FIG. 12 shows resin temperature changes of a case in which the die temperature is 50 degrees C. and a case in which the die temperature is 80 degrees C. That is, in the case in which the die temperature is 50 degrees C., a melted resin is solidified immediately after supplying of gas, so that it is difficult to perform the air assist.

It is necessary to set the temperature of the respective dies depending on the kind of resin as described hereinafter.

### 1. Temperature Range of the Fixed Die 1

If the resin is a crystalline resin, the fixed die 1 has a temperature of from a crystallization temperature +50 degrees C. to the crystallization temperature −50 degrees C. If the resin is a noncrystalline resin, the fixed die 1 has a temperature of from a glass-transition temperature +50 degrees C. to the glass-transition temperature −50 degrees C.

### 2. Temperature Range of the Movable Die 2

If the resin is a crystalline resin, the movable die 2 has a temperature of from the movable die temperature −10 degrees C. to the movable die temperature −50 degrees C. If the resin is a noncrystalline resin, the movable die 2 has a temperature of from the movable die temperature −10 degrees C. to the movable die temperature −50 degrees C.

(1) In a case in which the temperature of the die is within the above predetermined range (see FIG. 14(c)), the melted resin 4 closely contacts the fixed die 1 and it is solidified on the side of the fixed die 1 faster than on the side of the movable die 2. Therefore, the sink mark h is concentrated on the product proximate to the movable die 2, and it is not formed on the product proximate to the fixed die 1.

(2) In a case in which the temperature of only the movable die 2 exceeds the above predetermined range (see FIG. 14(d)), a portion of the melted resin 4 cannot be separated from the movable die 2, so that sink marks are formed on both surfaces of the product.

(3) In a case in which the temperature of only the fixed die 1 exceeds the above predetermined range (see FIG. 14(e)), the solidified layer 4a is formed thinly and cannot have sufficient strength to resist volume contraction, so that sink marks are formed on both surfaces of the product.

(4) In a case in which the temperature of only the movable die 2 does not reach the above predetermined range (see FIG. 14(b)), the melted resin 4 is solidified fast on the side of the movable die 2, so that the solidified layer 4b is formed thickly, and sink marks are formed on both surfaces of the product.

(5) In a case in which the temperature of only the fixed die 1 does not reach the above predetermined range (see FIG. 14(a)), the melted resin 4 cannot closely contact the fixed die 1, so that sink marks are formed on both surfaces of the product.

The pressure of the supplied gas to the cavity 3 is desirably 0.1 to 0.6 MPa. When the pressure of the supplied gas is less than 0.1 MPa, the separation of the melted resin 4 from the movable die 2 is incompletely performed, so that the sink marks are easily formed on the rib R on the surface of the product W. On the other hand, when the pressure of the supplied gas exceeds 0.6 MPa, the gas intrudes to the cavity surface of the fixed die 1, so that the surface of the product W becomes corrugated. The delay time from the time at which the supplying of the melted resin 4 is started to the time at which the supplying of the gas is started is desirably from 0 to 5 seconds. The supplying time of the gas is desirably from 2 to 40 seconds.

In the embodiment, since maintenance process of pressure on the melted resin 4 is not performed, the pressure of the supplied gas can be low. In addition, since the air from the factory or the like can be used for the supplying of the gas, no special apparatus is necessary, so that the apparatus cost can be reduced.

In addition, as shown in FIG. 13, since maintenance process of pressure on resin is unnecessary, the cycle time is shortened and the productivity can be improved.

1. A molding method for a resin product having a thick portion projecting outwardly on a rear surface of the resin product, comprising:
a first step for supplying a melted resin into a cavity of a die by an amount which is less than a volume of the cavity, the cavity having a surface side cavity surface corresponding to a surface of the resin product and a rear surface side cavity surface corresponding to the rear surface of the resin product;
a second step for supplying a gas from the rear surface side cavity surface of the cavity into the cavity, so that the melted resin is separated from the rear surface side cavity surface of the cavity and closely contacts the surface side cavity surface of the cavity; and
a third step for solidifying the melted resin maintained in the condition set in the second step.

2. The molding method according to claim 1, wherein
a recess for forming the thick portion of the resin product is provided on the rear surface side cavity surface of the cavity, and the gas is supplied from a bottom surface of the recess and a neighborhood of the recess into the cavity.

3. The molding method according to claim 1, wherein
the gas is supplied at a pressure of 0.1 to 0.6 MPa with respect to the cavity.

4. The molding method according to claim 1, wherein
in the third step, the surface side cavity surface has a temperature higher than that of the rear surface side cavity surface.

5. A molding apparatus for a resin product having a thick portion projecting outwardly on a rear surface of the resin product, comprising:
a supplying control device for supplying a melted resin into a cavity of a die by an amount which is less than a volume of the cavity, the cavity having a surface side cavity surface corresponding to a surface of the resin product and a rear surface side cavity surface corresponding to the rear surface of the resin product;
a gas supplying device for supplying a gas from the rear surface side cavity surface of the cavity into the cavity, so that the melted resin is separated from the rear surface side cavity surface of the cavity and closely contacts the surface side cavity surface of the cavity; and
a temperature control device for controlling a temperature of the surface side cavity surface so as to be higher than that of the rear surface side cavity surface.

6. The molding apparatus according to claim 5, wherein
the molding apparatus further comprising:
a recess which is provided on the rear surface side cavity surface of the cavity and is used for forming the thick portion of the resin product; and
opening portions which are provided at a bottom surface of the recess and a neighborhood of the recess and via which the gas is supplied into the cavity.

7. The molding apparatus according to claim 5, wherein
the gas is supplied at a pressure of 0.1 to 0.6 MPa with respect to the cavity.
